(19) United States
(12) Patent Application Publication
(10) Pub. No.: US 2004/0016276 A1
(43) Pub. Date: Jan. 29, 2004

(54) Controlled release fertilizer having improved mechanical handling durability and method for production thereof

(76) Inventors: Nick P. Wynnyk, Edmonton (CA); Eugene G. Stelmack, Fort Saskatchewan (CA); Nicolette M. Babiak, Gibbons (CA); Leslie L. Carstens, Thorhild (CA); J. David Eastham, Sherwood Park (CA); Baozhong Xing, Calgary (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/205,490

(22) Filed: Jul. 26, 2002

(51) Int. Cl. C05G 5/00

(52) U.S. Cl. 71/64.11

(57) ABSTRACT

A controlled release fertilizer material comprising a particulate plant nutrient surrounded by a protective coating comprising at least one substantially homogeneous layer of a urethane-containing compound and a filler(s). An organic additive(s) may or may not be present.

### BACKGROUND OF THE INVENTION

1. Field of the Invention

The present invention relates to a controlled release fertilizer having improved mechanical handling durability and to a method for production thereof.

2. Description of the Prior Art

Fertilizers have been used for many years to supplement nutrients in growing media.

In recent years the art has focused on techniques to deliver controlled amounts of plant nutrients to the soil or other growing media. This has been done so that, on one hand, the growing plants are not adversely deprived of nutrients and, on the other hand, an over supply of nutrients is avoided. An over supply of nutrients can result in toxicity to the plants or losses from leaching. The resulting improvement in FUE (fertilizer use efficiency) can reduce the rate and the frequency of nutrient application.

U.S. Pat. No. 5,538,531 [Hudson et al. (Hudson)] and the prior art cited therein provides a useful overview of methods of conveying controlled release properties to a particulate plant nutrient. Specifically, Hudson teaches a controlled release, particulate fertilizer product having a water soluble fertilizer central mass encased in a plurality of water insoluble, abrasion resistant coatings. At least one inner coating is a urethane reaction product derived from recited isocyanates and polyol. The outer coating is formed from an organic wax having a drop melting point in the range of from 50° C. to 120° C. The general teachings of Hudson and those of the Examples in Hudson make it clear that the Hudson process involves curing the urethane coating(s) around the particulate plant nutrient and, thereafter, applying to the cured urethane coating(s) the outer layer of organic wax.

It is also known in the art to pre-coat particulate plant nutrient (U.S. Pat. No. 6,039,781) with organic oil and particles as a means to regularize or otherwise improve the release profiles of the particulate plant nutrient.

U.S. Pat. No. 6,358,296 [Markusch et al. (Markusch)] teaches a slow-release polyurethane encapsulated fertilizer using oleo polyol(s). Specifically, Markusch teaches a process which involves using an isocyanate-reactive component or a polyisocyanate component to fertilizer products to form coated fertilizer products followed by application of the other reactive half of the system to form polyurethane encapsulated fertilizer particles. The purported point of novelty in Markusch is the discovery that the use of oleo polyol(s) leads to the production of a controlled release fertilizer having improved release properties (see Examples 1-4 of Markusch).

Despite these advances in the art, there is still some room for improvement. Specifically, it would be desirable to have a controlled release fertilizer and process for production thereof which would allow for the ready customization of the release rate profile of a given particulate plant nutrient having applied thereto a given amount of urethane coating(s). It would also be desirable to be able to achieve a desirable release rate profile for a given particulate plant nutrient using significantly reduced amounts of coating materials.

It would also be highly desirable to have a controlled release fertilizer material with improved durability properties during handling and storage. Specifically, while it is known to use coatings such as polyurethane coatings to control the release rate of the nutrients in the fertilizer to the surrounding soil at a specified rate, problems are often experienced when the coated product is exposed to mechanical handling (e.g., during blending with other materials, packaging, transportation and the like). Thus, when the coating is damaged during handling, the release profile of the product can be severely altered notwithstanding the advances in coating technology mentioned above.

To increase the resistance of the coated fertilizer to the mechanical damage from the handling process, some work has been done by applying a protective coating atop the release control coating.

International Patent Publication Number WO 95/26942 teaches that even relatively minor impacts and abrasions from handling can damage sulphur coatings that have been applied to fertilizer substrates. Tests used to simulate handling induced damage include dropping a sample of fertilizer from a height of 20 feet and manually shaking a sample of fertilizer in a sealed glass jar for 30 seconds. Damage from these test procedures is shown to be reduced by the application of a wax and/or polymer coating applied atop the sulphur coating.

U.S. Pat. No. 5,698,002 (Hudson) teaches development of abrasion resistant coatings atop an epoxide resin coated fertilizer substrate. The water insoluble, abrasion resistant coating is produced from waxes, thermoplastic polymers or polymers other than epoxides. Abrasion resistance is determined by subjecting 30 grams of the coated product to five sequential drops though a 6 foot long by 5 inch diameter pipe. After this test, the abraded fertilizer has a 7 day aqueous release rate (at 25° C.) of approximately 146% to 216% of the unabraded sample values. When subjected to the same drop test, commercially available SCU's suffered much more damage with release rates of up to 400% of the unabraded 7 day aqueous release test values.

The commercial application of the fertilizers has developed such that the fertilizers with different nutrients are mixed and blended together to provide balanced nutrients to the plants. The blending process can cause severe damage to the coated fertilizer as the blending process is much more severe than testing used in above-mentioned patents. Thus, there remains a need in the art for a controlled release fertilizer material which may include blends of different nutrients and has reduced susceptibility to damage, adverse affect on release profile properties and the like during production and/or as a result of mechanical handling thereof.

### SUMMARY OF THE INVENTION

It is an object of the present invention to obviate or mitigate at least one of the above-mentioned disadvantages of the prior art.

It is an object of the present invention to provide a novel controlled release fertilizer which obviates or mitigates at least one of the above-mentioned disadvantages of the prior art.

It is another object of the present invention to provide a novel process for producing such a controlled release fertilizer.

Accordingly, in one of its aspects the present invention provides a controlled release fertilizer material comprising a particulate plant nutrient surrounded by a protective coating which comprises a particulate filler. Preferably, there is a release control coating beneath the protective coating which provides the controlled release properties. The materials and the formulations of the release control coating and the protective coating can be the same or different. If they are the same, one coating functions as both controlled release coating and protective coating at the same time.

In another of its aspects, the present invention provides a process for producing a controlled release fertilizer material comprising the step of contacting a particulate plant nutrient with a protective coating comprising a particulate filler material to surround the particulate plant nutrient.

Thus, we have surprisingly and unexpectedly discovered that an improved controlled release fertilizer material and process for production thereof may be achieved if a particulate filler material is used in the protective coating that surrounds the fertilizer material. While this invention will have broad application, it is highly preferred to utilize the invention in a polyurethane type protective coating. Thus, it has been found that the addition of a number of different particulate materials to a polyol (e.g., castor oil, oleo polyol, and the like) or a mixture of polyols that is then reacted with an isocyanate or a mixture of isocyanates produces a coating that is less susceptible to damage during mechanical handling of the fertilizer material when compared to a polyurethane containing no particulate filler material. Of course, the manner by which the particulate filler material is added to the protective coating is not restricted. Thus, for example, it is possible to add the particulate filler to the isocyanate or to a mixture of the polyols and isocyanates or in conjunction with other non-reactive materials that serve to modify the release profile of the fertilizer product (e.g., wax, petroleum oil, bitumen, coal products, natural oils, pulp and paper products and the like that are premixed with polyol).

While not wishing to be bound by any specific theory or motive action, it is believed that the improved resistance to damage is obtained from a combination of the following factors:

a. The addition of a filler material provides a thicker coating that is more resistant to damage.

b. A matrix structure is formed in the filled coating.

c. With certain filler materials (e.g., those having high aspect ratios), the coating may be reinforced, thereby withstanding handling damage.

c. Some filler materials may serve to give the coating cushioning type properties (e.g., spherical starch).

d. Certain particulate filler materials are chemically reactive with one or more components of the coating material (e.g., with the isocyanate if the coating is a polyurethane coating).

Additionally, it has been surprisingly and unexpectedly discovered that the use of a particulate filler material in the protective coating can give a more desirable mechanical handling properties and maintain the release curve (e.g., slower front end while speeding up in later stages when plant nutrient requirements are higher).

Other advantages will become apparent to those of skill in the art having the present specification in hand.

As stated hereinabove, the present controlled release fertilizer material comprises a protective coating comprising a particulate filler material.

Preferably, the protective coating is derived from a mixture comprising: a polyol, an isocyanate, a filler and, optionally, an organic additive. Of course, those of skill in the art will recognize the mixture may contain more than one category of these materials (e.g., a mixture of two or more polyols, etc.). The polyol and isocyanate are chemically reactive and form a urethane. The organic additive (if present) is believed to be physically intermixed with the so-formed urethane—i.e., the preferred organic additive for use herein is believed to be substantially chemically inert to the polyol and the isocyanate components. The resultant coating is a substantially homogeneous layer. In other words, unlike the prior art approach taught by Hudson and by others involving multiple, distinct coatings of urethane and wax, the protective controlled release coating produced in this invention incorporates urethane, filler and organic additive in at least one substantially homogeneous layer (of course multiple such coatings are contemplated within the scope of the controlled release fertilize material). In this context, it will be understood that the term “homogeneous” is used in a somewhat broad sense for the purpose of excluding a controlled release fertilizer material comprising only distinct layers of urethane and wax (e.g., the fertilizer material taught by Hudson).

As used throughout this specification, the term “urethane-containing compound” is intended to mean a product obtained by reacting a polyol(s) and an isocyanate(s). Typically, the so-produced compound will be a polyurethane.

### BRIEF DESCRIPTION OF THE DRAWINGS

Embodiments of the present invention will be described with reference to the accompanying drawings, wherein like reference numerals denote like parts, and in which:

FIGS. 1-6 illustrate various comparative release profile curves for fertilizer materials produced in the Examples described below.

### DETAILED DESCRIPTION OF THE PREFERRED EMBODIMENTS

Accordingly, in one of its aspects, the present invention relates to a controlled release fertilizer material comprising a particulate plant nutrient surrounded by a coating.

The choice of particulate plant nutrient material useful for the present controlled release fertilizer material is not particularly restricted and is within the purview of a person skilled in the art.

For example, the plant nutrient material used may be selected from those disclosed in Hudson and/or Markusch. Preferably, such a plant nutrient comprises a water soluble compound, more preferably a compound containing at least one member selected from the group consisting of nitrogen, phosphorus, potassium, sulfur, micronutrients and mixtures thereof. A preferred such plant nutrient comprises urea. Other useful examples of plant nutrients are taught in U.S. Pat. No. 5,571,303 [Bexton]—e.g., ammonium sulfate, ammonium phosphate and mixtures thereof. Non-limiting examples of useful micronutrients may be selected from the group comprising copper, zinc, boron, manganese, iron and mixtures thereof.

Preferably, the coating surrounds the plant nutrient material in an amount in the range of from about 0.1 to about 10 percent by weight, more preferably from about 0.5 to about 7.0 percent by weight, based on the weight of the plant nutrient material.

Preferably, the protective coating is the reaction product of a mixture comprising: a polyol, an isocyanate. A protective coating comprises a particulate filler and, optionally, an organic additive.

There may be or may not be a separate release control coating underneath the protective coating. For example the coating could be applied atop a sulfur coated urea.

The materials and the formulation of the protective coating may be the same as, or different than the release control coating. If they are the same the coating functions as a release control and protective coating at the same time.

The particulate filler may comprise an organic material, an inorganic material or a combination of these.

The particulate filler may comprise natural materials, synthetic materials or a combination of these.

The particulate filler may be totally inert (gypsum), reactive (sulfur, starch), or partially reactive (urea) to the isocyanate.

Preferably, the particulate filler is selected from the group consisting of carbon black, polymer solids, foam (organic or inorganic), in-situ produced polyol solids, zeolites, clays, sulfur, coal dust, gypsum, starch, urea dust, rock dust, polysaccharides and mixtures thereof.

Preferably, the particulate filler has an average particle size of less than about 100 μm.

The optimal particle size for a given particulate filler may be readily determined by a person skilled in art having in hand this specification.

The choice of polyol is not particularly restricted and is within the purview of a person skilled in the art and, as stated above, it is possible to utilize two or more polyols. For example, the polyol may be a hydroxyl-terminated backbone of a member selected from the group comprising polyether, polyester, polycarbonate, polydiene and polycaprolactone, or a mixture thereof. Preferably, such a polyol is selected from the group comprising hydroxyl-terminated polyhydrocarbons, hydroxyl-terminated polyformals, fatty acid triglycerides, hydroxyl-terminated polyesters, hydroxymethyl-terminated polyesters, hydroxymethyl-terminated perfluoromethylenes, polyalkyleneether glycols, polyalkylenearyleneether glycols and polyalkyleneether triols. More preferred polyol are selected from the group comprising polyethylene glycols, adipic acid-ethylene glycol polyester, poly(butylene glycol), poly(propylene glycol) and hydroxyl-terminated polybutadiene—see, for example, British patent No. 1,482,213. The most preferred such polyol is a polyether polyol. Preferably, such a polyether polyol has a molecular weight in the range of from about 200 to about 20,000, more preferably from about 2,000 to about 10,000, most preferably from about 2,000 to about 8,000.

A particularly preferred class of polyol is that disclosed in Hudson. Preferably, such a polyol comprises from about 2 to about 6 hydroxyl moieties. More preferably, such a polyol comprises at least one C₁₀-C₂₂ aliphatic moiety. Most preferably, the polyol comprises castor oil.

Additionally, the polyol may be derived from natural sources such as soybean, corn, canola, soybean and the like (i.e., to produce naturally occurring modified oils). An example of such a synthetic polyol comprising a canola oil base is commercially available from Urethane Soy Systems Corp. (Princeton, Ill.).

Another class of polyol useful in the protective coating includes oleo polyols such as those described in Markusch.

A mixture of polyols may be useful in the protective coating, (for example, castor oil with oleo polyol(s), castor oil with polyethylene glycol, castor oil with polypropylene glycol).

The isocyanate suitable for used in producing the coating is not particularly restricted and the choice thereof is within the purview of a person skilled in the art. Generally, the isocyanate compound suitable for use may be represented by the general formula:

Q(NCO)ᵢ

wherein i is an integer of two or more and Q is an organic radical having the valence of i. Q may be a substituted or unsubstituted hydrocarbon group (e.g. an alkylene or arylene group). Moreover, Q may be represented by the general formula:

Q¹-Z-Q¹

wherein Q¹ is an alkylene or arylene group and Z is chosen from the group comprising—O—, —O-Q¹-, —CO—, —S—, —S-Q¹-S— and —SO₂—. Examples of isocyanate compounds which fall within the scope of this definition include hexamethylene diisocyanate, 1,8-diisocyanato-p-methane, xylyl diisocyanate, (OCNCH₂CH₂CH₂OCH₂O)₂, 1-methyl-2,4-diisocyanatocyclohexane, phenylene diisocyanates, tolylene diisocyanates, chlorophenylene diisocyanates, diphenylmethane-4,4-diisocyanate, naphthalene-1,5-diisocyanate, triphenylmethane-4,4,4-triisocyanate and isopropylbenzene-alpha-4-diisocyanate.

In another embodiment, Q may also represent a polyurethane radical having a valence of i. In this case Q(NCO)ᵢ is a compound which is commonly referred to in the art as a prepolymer. Generally, a prepolymer may be prepared by reacting a stoichiometric excess of an isocyanate compound (as discussed hereinabove) with an active hydrogen-containing compound (as discussed hereinabove), preferably the polyhydroxyl-containing materials or polyol(s) discussed above. In this embodiment, the polyisocyanate may be, for example, used in proportions of from about 30 percent to about 200 percent stoichiometric excess with respect to the proportion of hydroxyl in the polyols.

In another embodiment, the isocyanate compound suitable for use in the process of the present invention may be selected from dimers and trimers of isocyanates and diisocyanates, and from polymeric diisocyanates having the general formula:

[Q(NCOᵢ]ⱼ

wherein both i and j are integers having a value of 2 or more, and Q is apolyfunctional organic radical, and/or, as additional components in the reaction mixture, compounds having the general formula:

L(NCO)ᵢ

wherein i is an integer having a value of 1 or more and L is a monofunctional or polyfunctional atom or radical. Examples of isocyanate compounds which fall with the scope of this definition include ethylphosphonic diisocyanate, phenylphosphonic diisocyanate, compounds which contain a ═Si—NCO group, isocyanate compounds derived from sulphonamides (QSO₂NCO), cyanic acid and thiocyanic acid.

See also, for example, British patent No. 1,453,258.

Non-limiting examples of suitable isocyanates include: 1,6-hexamethylene diisocyanate, 1,4-butylene diisocyanate, furfurylidene diisocyanate, 2,4-toluene diisocyanate, 2,6-toluene diisocyanate, 2,4-diphenylmethane diisocyanate, 4,4-diphenylmethane diisocyanate, 4,4-diphenylpropane diisocyanate, 4,4-diphenyl-3,3′-dimethyl methane diisocyanate, 1,5-naphthalene diisocyanate, 1-methyl-2,4-diisocyanate-5-chlorobenzene, 2,4-diisocyanato-s-triazine, 1-methyl-2,4-diisocyanato cyclohexane, p-phenylene diisocyanate, m-phenylene diisocyanate, 1,4-naphthalene diisocyanate, dianisidine diisocyanate, bitoluene diisocyanate, 1,4-xylylene diisocyanate, 1,3-xylylene diisocyanate, bis-(4-isocyanatophenyl)methane, bis-(3-methyl-4-isocyanatophenyl)methane, polymethylene polyphenyl polyisocyanates and mixtures thereof.

A particularly preferred group of isocyanates are those described in Hudson and/or Markusch.

Preferably, the polyol(s) and isocyanate are used in amounts such that the ratio of NCO groups in the isocyanate to the hydroxyl groups in the polyol(s) is in the range of from about 0.8 to about 3.0, more preferably from about 0.8 to about 2.0, most preferably from about 0.9 to about 1.1.

If present, the organic additives may be selected from the group consisting of petroleum products (e.g., wax, paraffin oil, bitumen, asphalt, lubricants and the like), coal products (e.g., oil, lubricants, bitumen, wax and the like), natural products (e.g., canola oil, soybean oil, coconut oil, vegetable wax, animal fat, animal wax, forest products, such as tall oil, modified tall oil, tall oil pitch, pine tar and the like) and synthetic products (e.g, synthetic oils, waxes, polymers, lubricants and the like).

If wax is used, the wax suitable for use in the mixture to produce the coating may be selected from those described in Hudson and from silicon waxes (commercially available from Dow Corning). Thus, the preferred wax comprises a drop melting point of at least about 30° C., preferably in the range of from about 40° C. to about 120° C., more preferably in the range of from about 50° C. to about 120° C. More preferably, the wax is substantially non-tacky below a temperature of about 40° C. The preferred wax comprises a C₂₀₊ alpha olefin, more preferably a C₂₀₋₁₀₀ alpha olefin.

Preferably, the organic additive is present in the mixture in an amount of up to about 80 percent by weight, based on the combined weight of the organic additive and the polyol. More preferably, the organic additive is present in the mixture in an amount in the range of from about 1.0 to about 50 percent by weight, based on the combined weight of the organic additive and the polyol.

Step (a) in the present process comprises contacting a particulate plant nutrient with a mixture comprising: a polyol, an isocyanate, an organic additive and filler to produce a coating surrounding the particulate plant nutrient. The precise mode of applying the mixture to the plant nutrient is not particularly restricted—see, for example, column 5 lines 31-63 of Hudson.

Step (b) in the present process comprises curing the mixture of polyol and isocyanate to form a polyurethane coating.

In the present process, it is preferred to conduct Step (a) and (b) at a temperature in the range of from about 10° C. to about 180° C., more preferably in the range of from about 20° C. to about 150° C., most preferably in the range of from about 30° C. to about 120° C. Preferably, the coating steps are conducted at a temperature under the melting point of the substrates.

The organic additive can be premixed with the polyol or isocyanate.

The particulate filler can be mixed with the polyol, or isocyanate, and/or additive. The filler can be mixed with the particulate plant nutrient or the filler can be introduced separately into the coating during the coating forming process.

Step (a) can be conducted by contacting the particulate plant nutrient with a first stream comprising the polyol and a second stream comprising the isocyanate, the first stream and the second stream being independent of one another. The streams may also be applied in the opposite order. A third stream may be used, for example, comprising the particulate filler or a mixture of the filler and one of the other coating components. This third stream can be applied between the first and the second streams, or can be the first or last stream applied. The additive can be added separately as fourth stream. Alternatively mixtures of some or all components in the coating can be combined and applied in one or more streams. The mixing of coating components and order of introducing these streams into the system can be in any possible combination. These streams can be mixed in a nozzle before entering into the drum, or separately sprayed into the drum and mixed before contact with the fertilizer, or mixed on the surface of the fertilizer. Multiple application of these streams may be applied to obtain desired release and mechanical properties. There will be no separate layers (e.g., as distinct from Hudson discussed above and involving a polyurethane layer followed by wax overcoat).

Preferably, Step (a) comprises contacting the particulate plant nutrient with a first stream comprising the polyol component (with/without organic additive and/or filler) and a second stream comprising the isocyanate (with/without organic additive and/or filler), the first stream and the second stream being independent of one another. In this embodiment, the particulate plant nutrient may be contacted simultaneously with the first stream and the second stream. Alternatively, the particulate plant nutrient may be contacted with the second stream followed by the first stream. A third stream may also be used, for example, the particulate filler or the mixture of the filler and the organic additive. The third stream can be used in the middle of the first and the second stream or be the last one. The additive can be added separately as fourth stream. Alternatively mixtures of some or all components in the coating can be combined and applied in one or more streams. The mixing and order of introducing these streams into the system can be any possible combination. In a further preferred embodiment, Steps (a) and (b) of the present process may be repeated at least once to produce a controlled release fertilizer material having a plurality of coating layers.

Embodiments of the present invention will be illustrated with reference to the following examples which should not be used to limit or construe the invention.

### EXAMPLE 1

In this Example, a controlled release fertilizer material was prepared according to the teachings of U.S. Pat. No. 5,538,531 [Hudson et al. (Hudson)]. Accordingly, it will be recognized that this Example is provided for comparative purposes only and is outside the scope of the present invention.

The apparatus used in this Example was capable of applying coating components to a 7.5 kg batch. The apparatus consisted of a Plexiglas horizontal drum 16 inches in diameter and 20 inches in length. The drum end plates had a central 5 inch hole through which the coating components and the substrate are added. The drum internals consisted of four substantially evenly spaced longitudinal baffles, each baffle being about 1 inch in height. The drum was rotated at 75 fpm peripheral speed or about 18 rpm using a Separ™, variable speed drive, horizontal drum roller. The internal temperature of the drum and substrate was maintained at about 75° C. using variable setting electric heating guns. The heating guns were positioned to direct hot air through the holes in the drum end plates.

The coating components were added at a substantially consistent rate using individual Masterflex™ peristaltic pumps and a modified Amacoil™ Machinery auto-sampler. The sampler portion was removed and an individual stainless steel tubing for each component was attached to the drive assembly. This allowed the coating components to be distributed the full length of the drum at a substantially constant travel speed.

The substrate used in this Example was granulated urea (46-0-0). This substrate had a SGN (Size Guide Number) of 240. The substrate (7.5 kg) was preheated in an oven to about 75° C. and was allowed to roll in the coating drum until the temperature has stabilized to 75° C.

The polyol used in this Example was commercially available castor oil in an amount of 42.95 g. The isocyanate used in this Example was polymeric diphenylmethane diisocyanate (BASF PAPI No. 17) in an amount of 19.52 g. The two components are simultaneously added to the coating apparatus through individual lines or pipettes near the top of the rolling bed. The 2.5 weight percent coat was applied to the substrate in three substantially equal layers with about six minutes between applications of each layer—i.e., the weight of the total coat was 2.5 weight percent based on the weight of the substrate.

A C₃₀₊ alpha olefin wax commercially available from Chevron was pre-heated to about 150° C. and then was applied in a single layer to the urethane coated substrate. The wax was used in an amount to provide a weight of 1.5 weight percent based on the weight of the substrate. Six minutes after the wax was applied, the drum and contents are cooled with a controlled stream of pressurized air to about 35° C.

Thus, in this Example, the sum of the urethane coat and the wax layer was 4 weight percent based on the weight of the substrate.

A paint shaker simulation test is conducted to evaluate the mechanical handling durability.

The “paint shaker simulation” test used to simulate the damage to the controlled release coating is conducted in a paint shaker machine. First 200 grams of the controlled release fertilizer are placed in a 6″ diameter by 5.5″ deep metal can with lid. Then 8 (¼ inch by ½ inch) machine bolts with slotted heads and 8 (¼ inch) square head nuts are added in the can. The can with the controlled release fertilizer, nuts, and bolts is then placed securely in a paint conditioner/shaker (Red Devil, ¼ H.P. model). The test sample is vigorously conditioned in the paint shaker at frequency of 730 cycles per minute for 6 minutes. The operating time is controlled with an electronic timer (Gralab model 451) that automatically stops the paint shaker at the preset time. After the paint shaker cycling is complete the can is removed and the nuts and bolts are removed by passing the contents through a 3½ mesh screen. The controlled release fertilizer is collected in a pan and returned to its sample bag for the release rate analysis.

A comparison test has been conducted to correlate the simulation effect of the paint shaker with the damage in some commercial fertilizer blenders. The operating time of the paint shaker and the number of the bolts and nuts are determined based on the comparison test. The presetting of these parameters in the test for the work in this patent can simulate properly the damage in the commercial fertilizer blenders.

A comparison test has been conducted between the paint shaker test and the drop test from 20 feet high three times. The damage from the paint shaker is double of that from the 20-foot drop simulation. It is recognized that the paint shaker test is a severe test compared to those cited in other patents and patent applications referred to above, but better reflects actual handling induced damage.

The water release rate profile for the controlled release fertilizer material before and after the paint shaker simulation test was then determined. In the analysis, a Technicon AutoAnalyzer™ was calibrated and used pursuant to the teachings of Automated Determination of Urea and Ammoniacal Nitrogen (University of Missouri, 1980). The following procedure was used:

1. Accurately weigh 15 grams (10.1 mg) of the sample into a weigh dish. Record the weight of sample. Transfer the sample to 125 mL Erlenmeyer flask.

2. Add 75 mL of demineralized water and stopper the flask.

3. Gently swirl the sample and water until all the particles are submersed.

4. Let the sample stand for a specified time at a constant temperature (typically at room temperature).

5. Gently swirl the flask to mix the solution and decant only the solution to a 100 mL volumetric flask.

6. Rinse the sample with demineralized water adding to the volumetric flask.

7. Bulk to volume of volumetric flask and mix thoroughly.

8. If the test is to be repeated for another time period, repeat starting at Step 2.

9. Once the Technicon AutoAnalyzer II is on line, transfer some of this solution (or perform the required dilutions if necessary) to the Technicon sample cups for analysis.

10. Record the results as parts per million N—NH₃ (read directly from a Shimadzu Integrator).

### EXAMPLE 2

In this Example, a controlled release fertilizer was prepared for comparison purposes.

In Example 2, a 1 kg sample of urea was loaded into the 12 inch diameter drum and heated while rotating to 75° C. with the electric heat gun. A mixture of 5% by wt. C30+ wax in castor oil was heated to 115° C. on an electric hotplate. A volume of this mixture equivalent to 3.5 grams and a volume of isocyanate equivalent to 1.5 grams were applied simultaneously to the urea at 75° C. After 6 minutes rotation a second identical coat was applied. A 3rd coat was applied after an additional 6 minutes. 6 Minutes after the 3rd coat was applied, a 10 gram portion of C30+ wax heated to 115° was applied as an overcoat layer. The heat source was removed and the sample was air cooled with compressed air. After 12 minutes the sample had cooled below 30° C., the drum rotation was stopped and the sample was removed. A sample with a 1.5% total weight polyurethane coating and a 1% total weight C30+ wax overcoat is ready to do the release test.

The water release rate profile for the controlled release fertilizer material before and after the paint shaker was then determined using the test procedure described above in Example 1. The results are shown in FIG. 2.

### EXAMPLE 3

In this Example, a controlled release particulate fertilizer was prepared in accordance with the present invention.

As in Example 2, a 1 kg charge of urea was coated as follows. Two layers, each comprised of a mixture of 1.2 grams C30+ wax in 5.47 grams castor oil at 115° C. and 2.33 grams isocyanate. A period of 6 minutes was allowed between application of the next layer. Two further layers, each comprised of mixture A: (5.6 grams<38 micron Urea dust and 12.9 grams castor oil) and 6.48 grams of isocyanate were applied in an overcoat application. 6 minutes after application of the components of the 4th layer the sample was cooled as in Example 1. A 200-gram portion of the sample was subjected to the paint shaker test and along with the original sample was tested for the release rate in water.

### EXAMPLE 4

In this Example, a controlled release fertilizer was prepared in accordance with the present invention.

Example 4 represents the application of this concept in all layers of a controlled release coat on Urea. 1 kg of urea was coated in the previously described equipment. In this Example, one mixture comprised of (3.16 grams pea starch, 2.52 grams C30+ wax and 10.11 grams castor oil at 115° C.) was simultaneously applied with 4.21 grams of isocyanate. After 6 minutes a second layer like the first was applied. After a further 6 minutes a final layer like the first two layers was applied. 6 minutes later the sample was cooled as in Examples 2 and 3, and a 200-gram portion of the material was subjected to the paint shaker test. The original and after paint shaker samples were then tested for their release rates in water.

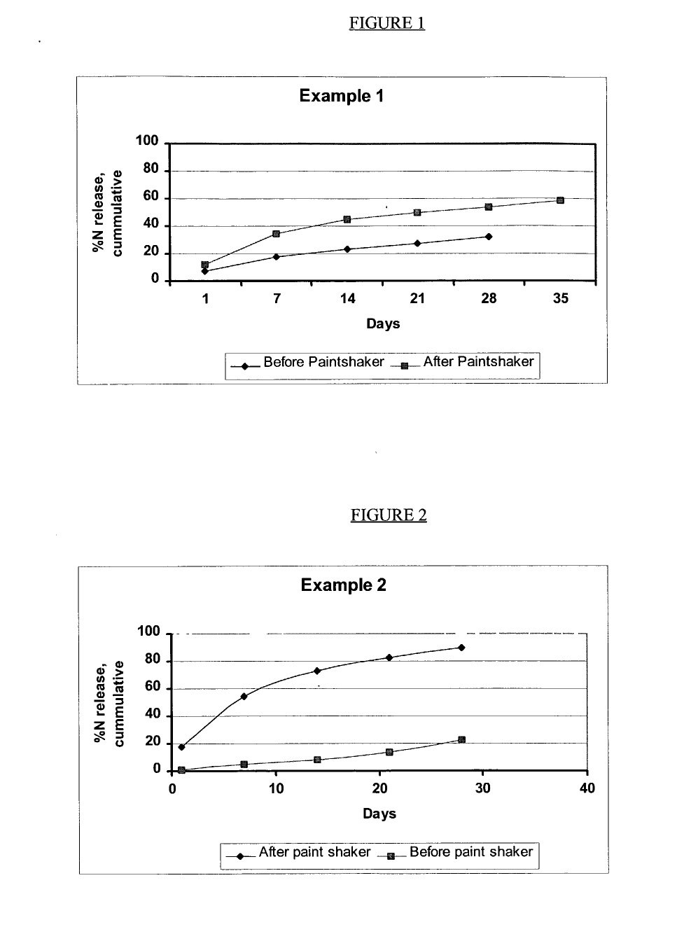

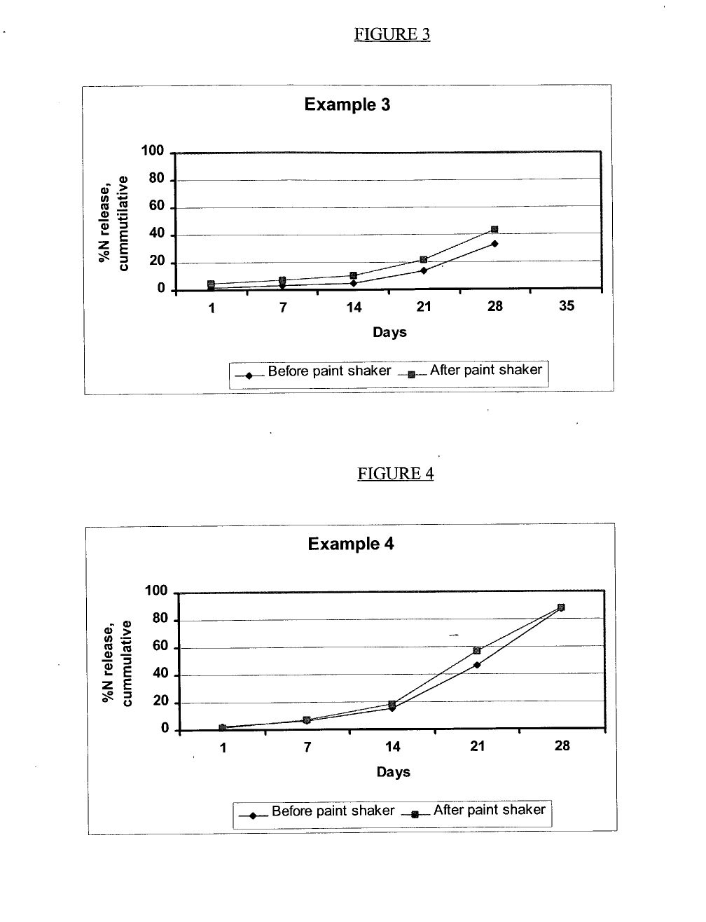

The water release rate profiles for the controlled release fertilizer material produced in Examples 1-4 are illustrated in FIGS. 1-4, respectively.

### EXAMPLE 5

In Example 5, a 1 kg sample of urea was loaded into the 12 inch diameter drum and heated while rotating to 75° C. with the electric heat gun. A mixture of 10% by wt. C30 HA wax in castor oil was heated to 115° C. on an electric hotplate. 20% by weight of <38 micron phosphogypsum (a non-reactive inorganic filler) was then stirred into the wax/castor oil mixture A volume of this mixture equivalent to 11.52 grams and a volume of isocyanate equivalent to 4.15 grams were applied simultaneously to the urea at 75° C. After 6 minutes rotation a second identical coat was applied. A 3^{rd} coat was applied after an additional 6 minutes. A 4^{th} layer was applied after a further 6 minutes. The heat source was removed and the sample was air cooled with compressed air. After 12 minutes the sample had cooled below 30° C., the drum rotation was stopped and the sample was removed.

A 200 gram portion of the sample was removed and subjected to the paint shaker simulated handling test. The samples before and after the paint shaker test were analyzed for the % of N released in water as described above and the results are illustrated in FIG. 5.

### EXAMPLE 6

In Example 6, a 1 kg sample of urea was loaded into the 12 inch diameter drum and heated while rotating to 75° C. with the electric heat gun. A mixture of 10% by wt. C30 HA wax in castor oil was heated to 115° C. on an electric hotplate. 20% by weight of <38 micron phosphate rock dust (a non-reactive inorganic filler) was then stirred into the wax/castor oil mixture A volume of this mixture equivalent to 11.52 grams and a volume of isocyanate equivalent to 4.15 grams were applied simultaneously to the urea at 75° C. After 6 minutes rotation a second identical coat was applied. A 3^{rd} coat was applied after an additional 6 minutes. A 4^{th} layer was applied after a further 6 minutes. The heat source was removed and the sample was air cooled with compressed air. After 12 minutes the sample had cooled below 30° C., the drum rotation was stopped and the sample was removed.

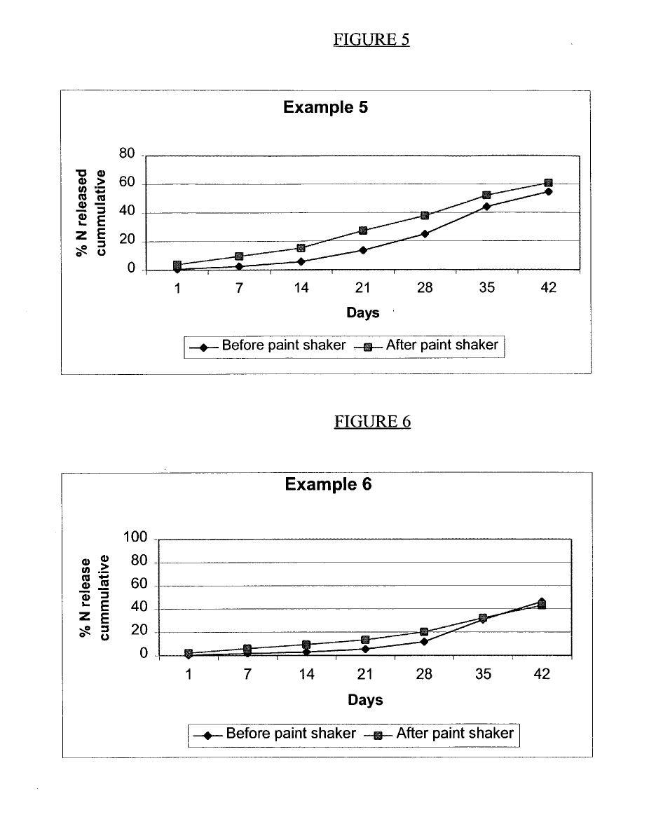

A 200 gram portion of the sample was removed and subjected to the paint shaker simulated handling test. The samples before and after the paint shaker test were analyzed for the % of N released in water as described elsewhere and the results are illustrated in FIG. 6.

As shown in the above Examples, the particulate filler(s) can improve the mechanical handling properties of the product. The release profiles of the samples with filler (Examples 3 and 4) after the paint shaker simulation have little or no change compared to the original samples. Comparing with the results in Examples 1-2, it is found that the mechanical handling property improvement is from the function of the fillers, not just simply from the thickness increase.

With reference to Example 4, while the water release rate profile has no noticeable change after the paint shaker simulation test, this was achieved by using a homogeneous coating with both of the controlled release and protective functions.

Examples 5-6 illustrate the use of relatively non-reactive inorganic filler material (i.e., reactivity compared to the other filler materials used in the Examples).

Accordingly, the material of Example 3-6 and the production thereof are a significant advance over the prior art.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

What is claimed is:

1. A controlled release fertilizer material comprising a particulate plant nutrient surrounded by protective coating which comprises a particulate filler.

2. The controlled release fertilizer defined in claim 1, further comprising a release control coating which provides the controlled release properties to the material.

3. The controlled release fertilizer defined in claim 2, wherein release control coating and the protective coating are distinct layers.

4. The controlled release fertilizer defined in claim 2, wherein release control coating and the protective coating are integral.

5. The controlled release fertilizer defined in claim 2, wherein the release control coating comprises at least one of urethane coating with an organic additive, urethane coating, polymer coating and sulfur coating.

6. The controlled release fertilizer defined in claim 1, wherein the particulate filler comprises an organic material or a mixture of organic materials.

7. The controlled release fertilizer defined in claim 1, wherein the particulate filler comprises an inorganic material or a mixture of inorganic materials.

8. The controlled release fertilizer defined in claim 1, wherein the particulate filler comprises a mixture of organic materials and inorganic materials.

9. The controlled release fertilizer defined in claim 1, wherein the particulate filler comprises a natural material or a mixture of natural materials.

10. The controlled release fertilizer defined in claim 1, wherein the particulate filler comprises a synthetic material or a mixture of synthetic materials.

11. The controlled release fertilizer defined in claim 1, wherein the particulate filler comprises a mixture of natural materials and synthetic materials.

12. The controlled release fertilizer defined in claim 1, wherein the particulate filler comprises an inert material.

13. The controlled release fertilizer defined in claim 12, wherein the inert material is selected from the group consisting of carbon black, polymer, foam, in-situ produced polyol solid, zeolites, clay, sulfur, coal dust, gypsum, starch, urea dust, other fertilizer dust, rock dust, polysaccharides and mixtures thereof.

14. The controlled release fertilizer defined in claim 12, where the inert material comprises gypsum.

15. The controlled release fertilizer defined in claim 1, wherein the particulate filler comprises a material reactive with the protective coating.

16. The controlled release fertilizer defined in claim 15, wherein the material reactive with the protective coating comprises a member selected from the group consisting of sulphur, starch, polysaccharides, urea and mixtures thereof.

17. The controlled release fertilizer defined in claim 1, wherein the particulate filler has an average particle size of less than about 100 μm.

18. The controlled release fertilizer defined in claim 1, wherein the protective coating comprises a polymeric coating.

19. The controlled release fertilizer defined in claim 18, wherein the polymeric coating comprises an isocyanate-based polymer.

20. The controlled release fertilizer defined in claim 18, wherein the polymer coating comprises the reaction product of a mixture comprising an active hydrogen-containing compound and an isocyanate.

21. The controlled release fertilizer defined in claim 18, wherein the polymeric coating comprises the reaction product of a mixture comprising an active hydrogen-containing compound, an isocyanate and an organic additive.

22. The controlled release fertilizer defined in claim 20, wherein the active hydrogen-containing compound comprises a polyol or mixture of polyols.

23. The controlled release fertilizer material defined in claim 1, wherein the plant nutrient comprises a water soluble compound.

24. The controlled release fertilizer material defined in claim 23, wherein the water soluble compound comprises a compound containing at least one member selected from the group consisting of nitrogen, phosphorus, potassium, sulfur and mixtures thereof, and optionally one or more micronutrients.

25. The controlled release fertilizer material defined in claim 1, wherein the plant nutrient comprises urea.

26. The controlled release fertilizer material defined in claim 22, wherein the polyol comprises from about 2 to about 6 hydroxyl moieties.

27. The controlled release fertilizer material defined in claim 22, wherein the polyol comprises castor oil.

28. The controlled release fertilizer material defined in claim 22, wherein the polyol comprises an oleo polyol.

29. The controlled release fertilizer material defined in claim 22, wherein the polyol comprises a glycol or derived polyol.

30. The controlled release fertilizer material defined in claim 22, wherein the polyol comprises a mixture of castor oil and oleo polyols.

31. The controlled release fertilizer material defined in claim 20, wherein the isocyanate is selected from the group consisting of diphenylmethane diisocyanate, toluene diisocyanate, aliphatic isocyantes, derivatives thereof, polymers thereof and mixtures thereof.

32. The controlled release fertilizer material defined in claim 20, wherein the isocyanate contains from about 1.5 to about 3.0 isocyanate groups per molecule.

33. The controlled release fertilizer material defined in claim 20, wherein the isocyanate contains from about 10% to about 50% NCO.

34. The controlled release fertilizer material defined in claim 20, wherein the isocyanate comprises polymeric diphenylmethane diisocyanate.

35. The controlled release fertilizer material defined in claim 1, wherein the protective coating comprises an organic additive.

36. The controlled release fertilizer material defined in claim 35, wherein the organic additive is selected from the group consisting of petroleum products, coal products, natural products and synthetic products.

37. The controlled release fertilizer material defined in claim 35, wherein the organic additive comprises an organic wax.

38. The controlled release fertilizer material defined in claim 37, wherein the organic wax comprises a drop melting point of at least about 30° C.

39. The controlled release fertilizer material defined in claim 37, wherein the organic wax is substantially non-tacky below a temperature of about 40° C.

40. The controlled release fertilizer material defined in claim 37, wherein organic wax comprises a C₂₀₊ alpha olefin.

41. The controlled release fertilizer material defined in claim 1, wherein the protective coating is present in an amount in the range of from about 0.1 to about 10 percent by weight based on the weight of particulate plant nutrient.

42. The controlled release fertilizer material defined in claim 1, wherein the coating is present in an amount in the range of from about 0.5 to about 7.0 percent by weight based on the weight of particulate plant nutrient.

43. The controlled release fertilizer material defined in claim 22, wherein the ratio of NCO groups from the isocyanate to the hydroxyl groups in the polyol in the mixture is in the range of from about 0.8 to about 3.0.

44. The controlled release fertilizer material defined in claim 22, wherein the ratio of NCO groups from the isocyanate to the hydroxyl groups in the polyol in the mixture is in the range of from about 0.8 to about 2.0.

45. The controlled release fertilizer material defined in claim 22, wherein the ratio of NCO groups from the isocyanate to the hydroxyl groups in the polyol in the mixture is in the range of from about 0.9 to about 1.1.

46. The controlled release fertilizer material defined in claim 22, wherein the amount of organic additive in the mixture is up to about 80 percent by weight based on the combined weight of the organic additive and the polyol.

47. The controlled release fertilizer material defined in claim 1, wherein the amount of filler in the mixture is in the range of from 0.1 to 85% based on the total weight of the protective coating.

48. The controlled release fertilizer material defined in claim 1, wherein the amount of filler in the mixture is in the range of from 1 to 50% based on the total weight of the protective coating.

49. The controlled release fertilizer material defined in claim 1, wherein the amount of filler in the mixture is in the range of from 3 to 30% based on the total weight of the protective coating.

50. A process for producing a controlled release fertilizer material comprising the step of contacting a particulate plant nutrient with a protective coating comprising a particulate filler material to surround the particulate plant nutrient.

51. The process defined in claim 50, wherein the particulate material is agitated during the coating step.

52. The process defined in claim 50, wherein the coating step is conducted at a temperature in the range of from about 110° C. to about 180° C.

53. The process defined in claim 50, wherein the coating is conducted at a temperature in the range of from about 20° C. to about 150° C.

54. The process defined in claim 50, wherein the coating is conducted at a temperature in the range of from about 30° C. to about 120° C.

55. The process defined in claim 50, comprising the steps of:
(a) contacting a particulate plant nutrient with a mixture comprising: a polyol, an isocyanate, an optional organic additive and the particulate filler material to produce a coating surrounding the particulate plant nutrient; and
(b) curing the coating to produce the controlled release fertilizer material.

56. The process defined in claim 50, wherein the coating step comprises contacting the particulate plant nutrient with a first stream comprising the polyol and a second stream comprising the isocyanate, the first stream and the second stream being independent of one another.

57. The process defined in claim 56, wherein the coating step comprises employing a third stream for the particulate filler.

58. The process defined in claim 56, wherein the first stream comprises a mixture of the polyol and the organic additive.

59. The process defined in claim 56, wherein Step (a) comprises contacting the particulate plant nutrient simultaneously with the first stream and the second stream.

60. The process defined in claim 56, wherein Step (a) comprises contacting the particulate plant nutrient with the first stream followed by the second stream.

61. The process defined in claim 51, wherein Steps (a) and (b) are repeated at least once to produce a controlled release fertilizer material having a plurality of coating layers.
